(19) United States
(12) Patent Application Publication
(10) Pub. No.: US 2005/0190809 A1
(43) Pub. Date: Sep. 1, 2005

(54) Ultraviolet, narrow linewidth laser system

(75) Inventors: Alan B. Petersen, Palo Alto, CA (US); James D. Kafka, Palo Alto, CA (US)

Correspondence Address: HELLER EHRMAN LLP, 275 MIDDLEFIELD ROAD, MENLO PARK, CA, 94025-3506, US

(73) Assignee: SPECTRA-PHYSICS, INC., MountainView, CA (US)

(21) Appl. No.: 11/031,977

(22) Filed: Jan. 7, 2005

Related U.S. Application Data
(60) Provisional application No. 60/534,480, filed on Jan. 7, 2004.

(51) Int. Cl. H01S 3/22

(52) U.S. Cl. 372/55

(57) ABSTRACT

A laser device is provided for generating an ultraviolet output. The device comprises a laser having at least one diode-pumped alkali metal vapor gain cell for generating a near infrared laser output, and at least two optically-nonlinear crystals. In one particular embodiment, the laser uses a Rb gas cell and generates radiation at a wavelength of about 199 nm and at least 200 mW of power with a linewidth of less than 10 GHz. In another embodiment, narrow linewidth UV light is generated at 265 nm.

### CROSS-REFERENCE TO RELATED APPLICATIONS

The present application claims the benefit of priority to co-pending U.S. Provisional Application Ser. No. 60/534,480 (Attorney Docket No. UVRB474978) filed Jan. 7, 2004. This application is incorporated herein by reference for all purposes.

### BACKGROUND OF THE INVENTION

1. Field of the Invention

This invention relates to laser equipment and more specifically, to ultraviolet (UV) laser systems with specific wavelength output and narrow linewidth.

2. Description of Related Art

As semiconductor devices achieve higher integration densities, optical systems for wafer and mask inspection as well as other manufacturing operations require shorter operating wavelengths. Although a variety of lasers can be adapted for these purposes the most generally applicable laser for semiconductor inspection would be a continuously operating (CW) device with a narrow linewidth (≦10 GHz) and a wavelength near one of the currently predominant photolithographic values, 248 and 193 nm. A number of known laser systems could be adapted for this purpose. On one end of the spectrum are CW ion lasers, demonstrated at wavelengths down to 219 nm. Such devices, however are very inefficient, requiring 10's of kW electrical input for <1 W optical output. Reliability of even well-engineered UV ion lasers in industrial environments has been shown to be poor, with high cost of ownership. At the opposite end of the spectrum are diode-pumped solid-state (DPSS) lasers, possessing high reliability, efficiency, compactness and much lower cost of ownership. However, the best developed DPSS lasers have fundamental operating wavelengths near 1000 nm, requiring wavelength upconversion into the UV. Phase-matching limitations in the most practical UV nonlinear crystals mean that usually four steps are required to convert the fundamental IR output into the 200 nm range. Furthermore, efficient CW nonlinear conversion requires high optical intensities, which practically, can only be obtained inside an active or passive resonator. Although intra-cavity second harmonic generation (ICSHG) is efficient and fairly common in CW lasers, additional frequency conversion steps are known to be increasingly difficult, costly and inefficient. Thus, a 200 nm system based exclusively on DPSS lasers loses most of the DPSS reliability, efficiency, complexity and cost advantages.

A more desirable laser for such inspection applications would have a fundamental wavelength in the range of 750-800 nm, allowing wavelength conversion to the 200 nm region with fewer steps. Preferably, such a laser would also be compatible with direct optical pumping by high power diode arrays. Lasers of this type include Cr:LiSAF, Cr:LiCAF and alexandrite as well as optically pumped semiconductor lasers. Although diode pumping of these tunable lasers has been demonstrated, high brightness, high reliability diodes with the requisite short wavelengths are not yet available with enough power to allow scaling to the tens of watts level required for useful harmonic generation. Ti:sapphire lasers can also emit CW radiation in the 750-800 nm requirement, and have been scaled to well over 20 W, but these lasers have significant disadvantage of requiring a CW diode-pumped green laser as a pump source, resulting in greater cost and complexity and lower overall electrical system efficiency.

Recently, Krupke in U.S. Pat. No. 6,643,311 described a new class of CW lasers based on direct laser diode pumping of alkali metal vapors. In particular, atomic rubidium (Rb) vapor was identified as a particularly promising medium as it could be pumped at 780 nm to generate laser radiation at 795 nm with high gain and high efficiency. Calculations show that with currently available high power, high brightness laser diode arrays tuned to emit light near the desired pump wavelength, such a diode-pumped rubidium gas laser can be scaled to high output powers by simply increasing the gas volume. Diode-pumped gas laser resonators that may be suitable for generating TEM₀₀ beams have also been described in U.S. Pat. No. 6,331,993 to Brown. Such configurations included but were not limited to end-pumped configurations, which are known to facilitate operation in low order transverse mode.

### SUMMARY OF THE INVENTION

Accordingly, one object of the present invention is to provide improved ultraviolet laser output using a simplified, robust configuration.

Another object of the present invention is to improve the power output and durability of CW lasers producing ultraviolet laser wavelengths.

Another object of the present invention is to use diode-pumped alkali lasers (DPALs) to generate narrow linewidth, sub-200 nm laser output.

At least some of these objects are achieved by some embodiments of the present invention.

In one embodiment of the present invention, an improved laser system is provided. The system comprises of a gas laser for producing near infrared output, a diode pump source for pumping the gas laser, and at least two nonlinear conversion stages. The laser system may produce a narrow linewidth ultraviolet output. In some embodiments, the ultraviolet output may have a wavelength less than 300 nm. The ultraviolet output may have a wavelength between 260 and 270 nm. The ultraviolet output may have a wavelength between 190 and 200 nm. It should be understood that the diode pump source may be selected from one of the following: a laser diode bar, a laser diode stack, or a laser diode array. The diode pump source may be selected from one of the following: an optically concentrated laser diode bar, an optically concentrated laser diode stack, or an optically concentrated laser diode array. The diode pump source may be line-narrowed. The ultraviolet output may be CW. In other embodiments, the ultraviolet output may be quasi-CW.

In one embodiment, the system may further include a line narrowing device to produce a narrower linewidth UV output. The line narrowing device may be an intra-cavity etalon. The system may include more than one diode-pumped gas laser. At least one of the nonlinear conversion stages may use a nonlinear crystal. The nonlinear crystal may be made of at least one of the following: LBO, BBO, CLBO, KNbO3, KBBF, PPLN, PPLT, BIBO, KABO, BABF, BABO, LB4 and GdYCOB. In one embodiment, at least one of the nonlinear conversion stages may be positioned so that nonlinear conversion takes place within an optical cavity of the gas laser. In other embodiments, at least one of the nonlinear conversion stages may be positioned so that the nonlinear conversion takes place within an external resonant cavity.

It should be understood that the gas laser may be an alkali metal vapor laser. The alkali metal vapor may be made of at least one of rubidium, cesium, potassium, sodium or lithium. Linewidth of the ultraviolet output may be less than 10 GHz. The power of the ultraviolet output may be more than 200 mW. In other embodiments, the power of the ultraviolet output is more than 500 mW or more than 1 W. The output may be used for inspection. The output may be used for semiconductor inspection. The output may be optically directed towards a semiconductor wafer. In the present embodiment, the diode pump source pumps the gas laser to produce near infrared output, wherein the near infrared output is converted by the at least two nonlinear conversion stages to produce a narrow linewidth ultraviolet output. The diode pump source may pump the gas laser to produce near infrared output, wherein the near infrared output is a beam passing through at least two nonlinear conversion stages to produce a narrow linewidth ultraviolet output. The output of the gas laser may be between 750 and 810 nm.

In another embodiment of the present invention, a method is provided for producing narrow linewidth ultraviolet light. The method comprises of providing a gas laser for producing near infrared output, a diode pump source for pumping the gas laser, and at least one nonlinear conversion stage. The method is used to produce an ultraviolet output that is a harmonic of the infrared output. The ultraviolet output according to this method may have a wavelength less than 300 nm. The ultraviolet output may have a wavelength between 260 and 270 nm. The ultraviolet output may have a wavelength between 190 and 200 nm. The diode pump source may be selected from one of the following: a laser diode bar, a laser diode stack, or a laser diode array. It should be understood that the diode pump source may also be selected from one of the following: an optically concentrated laser diode bar, an optically concentrated laser diode stack, or an optically concentrated laser diode array. The diode pump source may be line-narrowed. The ultraviolet output may be CW. The ultraviolet output may be quasi-CW.

In one embodiment, the method may further include a line narrowing device to produce a narrower linewidth UV output. The line narrowing device may be an intra-cavity etalon. The method may include using more than one diode-pumped gas laser. The nonlinear conversion stage may use a nonlinear crystal. The nonlinear crystal may be made of at least one of the following: LBO, BBO, CLBO, KNbO3, KBBF, PPLN, PPLT, BIBO, KABO, BABF, BABO, LB4 and GdYCOB. In one embodiment, the nonlinear conversion stage may be positioned so that nonlinear conversion takes place within an optical cavity of the gas laser. In other embodiments, the nonlinear conversion stage may be positioned so that the nonlinear conversion takes place within an external resonant cavity.

It should be understood that the gas laser may be an alkali metal vapor laser. The alkali metal vapor may be made of at least one of rubidium, cesium, potassium, sodium or lithium. Linewidth of the ultraviolet output may be less than 10 GHz. The power of the ultraviolet output may be more than 200 mW. In other embodiments, the power of the ultraviolet output is more than 500 mW or more than 1 W. The output may be used for inspection. The output may be used for semiconductor inspection. The output may be optically directed towards a semiconductor wafer. The output of the gas laser may be between 750 and 810 nm. The gas laser may be pumped by the diode pump source to produce the near infrared output which is received by the at least one nonlinear conversion stage, producing an ultraviolet output that is a harmonic of the infrared output.

In yet another embodiment of the present invention, another improved laser system is provided. The system may comprise of a high gain laser for producing output between 750 and 800 nm; a diode pump source for pumping the laser, and at least two nonlinear conversion stages. The laser system may produce a narrow linewidth ultraviolet output at a wavelength shorter than 300 nm.

In a still further embodiment according to the present invention, a laser device is provided for generating an ultraviolet output. The device comprises of a first laser having an alkali gain cell for generating a laser output, a first optically-nonlinear crystal, a second optically-nonlinear crystal, and optionally a third optically-nonlinear crystal. In this particular embodiment, the laser output passes through a configuration of the first optically-nonlinear crystal, the second optically-nonlinear crystal, and the third optically-nonlinear crystal to generate radiation at a frequency of about 198 to 200 nm and at least 200 mW of power.

In another embodiment of the present invention, a method is provided for generating a CW ultraviolet laser output. The method comprises of providing a first alkali gain cell; providing a first resonator around the gain cell, wherein the resonator incorporating a nonlinear element phase-matched for second harmonic generation, providing a second alkali gain cell; providing a second resonator around the second gain cell, wherein the second resonator incorporating a second nonlinear element phase-matched for third harmonic generation; pumping the first alkali gain cell with a first laser diode to provided a laser output from the first resonator at a first frequency in a range of about 397.5 to 400 nm; pumping the second alkali gain cell with a second laser diode; and directing the first laser output to the second resonator so that the second optically-nonlinear crystal mixes a fundamental frequency radiation from the second alkali gain cell with the first laser output to provide a second laser output having a second frequency different from the first frequency. The second frequency discussed above may be in the range of about 265 to 270 nm. The first alkali gain cell may be an rubidium (Rb) gain cell. The second alkali gain cell may be an Rb gain cell.

The method may further comprise of providing a third alkali gain cell; providing a third resonator around the third gain cell, wherein the third resonator incorporating a third nonlinear element phase-matched for third harmonic generation; pumping the third alkali gain cell with a third laser diode; and directing the laser output from the second resonator to the third resonator so that the third optically-nonlinear crystal mixes fundamental frequency radiation from the third alkali gain cell with the second laser output to generate radiation having a third frequency different from the second frequency. The second frequency may be in the range of about 198 to 200 nm. The third alkali gain cell may also be an Rb gain cell. The second optically-nonlinear crystal may be selected from one of the following: LBO, BBO or CLBO. The third optically-nonlinear crystal may be selected from one of the following: BBO or KBBF. Radiation from the first resonator may be configured to make a single pass through the second resonator, wherein the second resonator is part of a free-running Rb 795 nm laser. In some embodiments, each gain cell includes a capillary holding alkali vapor. The may use a device with a narrow linewidth of less than 10 GHzGHz. The laser may have an output of at least 200 mW and at least 500 mW in another embodiment.

In yet another embodiment of the present invention, an improved laser is provided. The laser may be a CW laser with a first module configured as an intra-cavity second harmonic generation laser. The first module may comprise of a first gain cell of rubidium configured to be pumped by a diode source of optical pump-light for causing a fundamental frequency radiation having a frequency in the range of 750 to 810 nm; a first resonator containing the first gain cell; and a first optically-nonlinear crystal located in the first resonator and arranged to convert the fundamental frequency radiation into radiation having a second frequency different from the fundamental frequency.

The laser may include a second module comprising a second gain cell of rubidium configured to be pumped by a diode source of optical pump-light for causing a fundamental frequency radiation having a frequency in the range of 750 to 810 nm; a second resonator containing the second gain cell; and a second optically optically-nonlinear crystal located in the resonator and arranged to mix radiation from the first module with the radiation from the second gain cell to generate radiation at a third frequency.

The laser may also include a third module comprising a third gain cell of rubidium configured to be pumped by a diode source of optical pump-light for causing a fundamental frequency radiation having a frequency in the range of 750 to 810 nm; a third resonator containing the third gain cell; and a third optically optically-nonlinear crystal located in the resonator and arranged to mix radiation from the second module with the radiation from the third gain cell to generate radiation at a fourth frequency. The laser may have a narrow linewidth of less than 10 GHz. The laser may have an output of at least 200 mW. In some embodiments, the laser may have an output of at least 500 mW, at least 1 watt, at least 2 watts, at least 4 watts. The laser may have a first resonator that is an optical cavity resonant at a wavelength, corresponding to a wavelength of the transition of an alkali atomic vapor. The laser may have a gain medium in the first gain cell comprises of a mixture of at least one buffer gas and the alkali atomic vapor. The laser may be pumped by at least one semiconductor diode laser emits at a wavelength of about 852 nm. The semiconductor diode laser may comprise of a material selected from the group consisting of AlGaAs and InGaAsP. The semiconductor diode laser may emit at a wavelength of about 780 nm. The laser may have a capillary through which the mixture flows or is contained.

In another embodiment of the present invention, an improved laser system is provided. The system may have a first diode-pumped alkali laser; a second diode-pumped alkali laser positioned to receive output from the first diode-pumped alkali laser; and a third diode-pumped alkali laser from the second diode-pumped alkali laser. The first alkali laser generates an output in the range of about 750 to 800 nm and laser output from the first diode-pumped alkali laser with a center line wavelength of about 198 to 200 nm. The alkali laser may be a Rb laser. The alkali vapor may be selected from the group consisting of cesium (Cs), rubidium (Rb), potassium (K), sodium (Na), and lithium (Li).

In yet another embodiment, the present invention may comprise of means for generating a laser output using an alkali gain cell; and means for converting the laser output to generate radiation at a frequency of about 198 to about 200 nm and at least 200 mW of power.

A further understanding of the nature and advantages of the invention will become apparent by reference to the remaining portions of the specification and drawings.

### BRIEF DESCRIPTION OF THE DRAWINGS

FIG. 1: Schematic of a configuration for diode array end-pumped Rb gain cell.

FIG. 2: Optical schematic for intra-cavity frequency doubling of the fundamental radiation from a Rb gain cell.

FIG. 3: Optical schematic of an intra-cavity frequency conversion of radiation from a Rb gain cell to sub-200 nm.

FIG. 4: Schematic of an alternative configuration for generating sub-200 nm CW output from a fundamental CW source operating at 795 nm.

FIG. 5: Schematic of another alternative for generating sub-200 nm radiation using three Rb gain cells.

FIG. 6: Schematic of a generic alternative for generating sub-200 nm radiation using ICSHG of a fundamental <800 nm CW laser source followed by resonant doubling of the resultant output.

FIG. 7: Schematic showing a plurality of cascaded Rb laser modules.

FIG. 8: Schematic showing one embodiment of a laser according to the present invention configured to inspect a surface.

### DESCRIPTION OF THE SPECIFIC EMBODIMENTS

The present invention is directed to methods and techniques for providing laser systems based on intra-cavity harmonic conversion of a diode-pumped gas laser. In particular, intra-cavity conversion to the fourth harmonic of a diode-pumped Rb vapor laser is disclosed, that is especially useful for semiconductor inspection, where a sub-200 nm CW source of power output on the order of at least 200 mW is desired. Although not limited to the following, application of the intra-cavity harmonic conversion techniques to other high gain CW sources operating near or just under 800 nm are included within the scope of the invention.

Thus 795 nm rubidium vapor laser exhibits several notable advantages with respect to intra-cavity frequency conversion into the sub-200 nm range. Thus the third harmonic of the fundamental radiation is at 265 nm and the fourth harmonic is at 198.7 nm, both of which are highly useful for semiconductor inspection and other applications. The high gain of the Rb laser transition (currently demonstrated at >25%/pass in laboratory experiments) affords a degree of tolerance against insertion losses, thereby facilitating high intra-cavity power buildup in a complex optical cavity containing nonlinear elements. Furthermore, the Rb vapor gain; medium does not exhibit the propensity to optical damage or adverse thermal lensing limitations often associated with solid-state laser crystals, allowing for simpler resonator designs. In particular, high gain characteristics of the laser medium allow use of optics with shorter focal lengths (on the order of 30-50 cm), making thermal lensing less severe and minimizing potential lensing issues on intra-cavity components such as windows and mirrors. In addition, the ability to use high Rb laser species density at a convenient temperature allows for high laser energy extraction from a relatively compact structure that is also conducive to operation in a stable TEM₀₀ mode. Since the gain occurs on a pressure-broadened vapor-phase atomic transition, the Rb emission is inherently narrow band, which makes it suitable for harmonic conversion. Further line narrowing is possible using conventional intra-cavity etalon techniques or injection locking Finally, the power from a diode-pumped Rb gas laser gain medium is scalable by increasing the cell length in a straightforward manner, an advantage shared by all gas lasers that are amenable to optical end-pumping by the appropriate wavelength from a high power density radiation source.

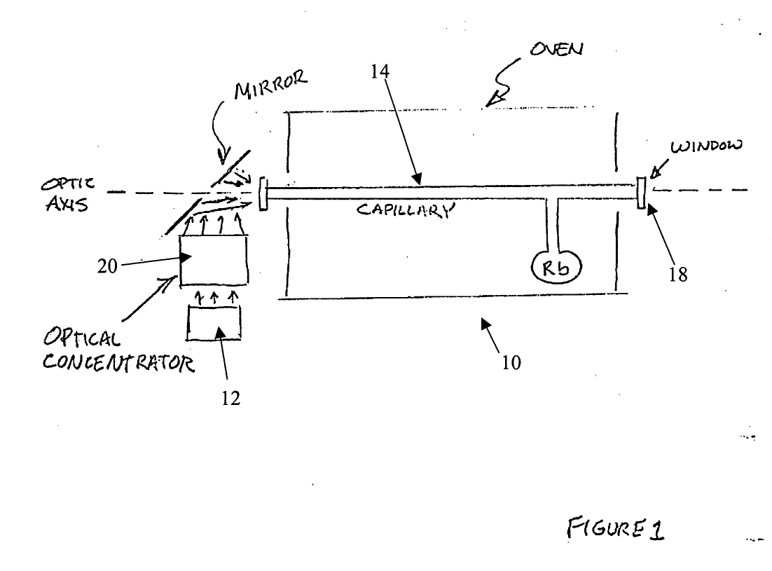

One embodiment of an Rb gain cell 10 end-pumped by 780 nm radiation from a pump source 12 is shown in FIG. 1. It should be understood that the pump source 12 may be but is not limited to a laser diode bar, a laser diode stack, or a laser diode array. A hollow capillary 14 with a reflective inner or outer surface and fitted with windows 18 at each end may be filled with helium and a gas such as ethane and attached to a sidearm containing rubidium metal. The assembly 10 is heated to a temperature between 100 and 300 deg. C. to provide the appropriate density of Rb vapor. Approaches to the design of appropriate gas gain cells suited to alkali metal vapors were specifically taught by Krupke in U.S. Pat. No. 6,643,311, included by reference herein for all purposes. In one embodiment, the pump light at ˜780 nm from a laser diode array 12 may be optically concentrated by an optical concentrator 20 such as but not limited to optical fibers, a telescope, hollow funnel, lens duct, or other beam shaping means. Excitation efficiency of the alkali vapor may be improved by narrowing the linewidth of the diode pump source. This can be accomplished by incorporating a volume Bragg grating into the diode pump source 12. The resulting diode pump source exhibits increased spectral and spatial brightness. In the end-pumped configuration shown, the pump radiation enters at least one end of the capillary 14, is guided down its length and absorbed by the Rb vapor. Laser energy may be extracted from the Rb gain cell 10 as an oscillator or amplifier by orienting a resonator or optical beam along the cell axis. Techniques for obtaining TEM₀₀ or low order transverse mode output from this type of an end-pumped configuration are known to persons skilled in the art. In particular, various approaches to designing diode-pumped gas lasers of scalable power output with high beam quality have been described by Brown in U.S. Pat. No. 6,331,993 and such techniques and approaches as may be applicable to the case of a Rb or other metal vapor gain media are incorporated by reference herein.

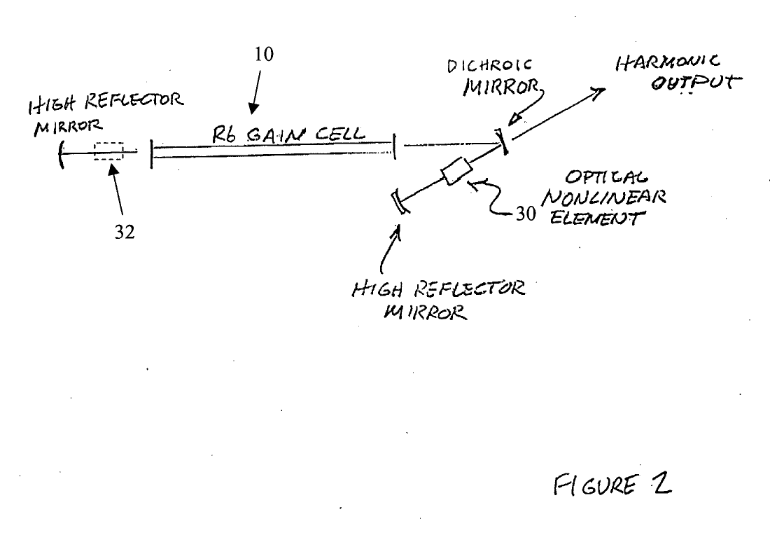

Using such a Rb gain cell 10 in the present embodiment, harmonics of 795 nm can be generated in a variety of ways. By constructing a 795 nm resonator around the gain cell 10 which incorporates a nonlinear element phase-matched for second harmonic generation, laser output at 397.5 nm may be produced. It should be understood that depending on the configuration, optical cavities resonant at other frequencies may also be used. One embodiment of a system according to the present invention is shown in FIG. 2. By example and not limitation, a crystal 30 such as LBO, BBO, CLBO, and periodically poled lithium tantalate (PPLT) may all be used in one nonlinear conversion stage for the present application. An intra-cavity second harmonic generation (ICSHG) method has been shown to produce harmonic output efficiently for CW lasers, most commonly at 1064 nm, but also at a variety of other wavelengths available from solid state lasers, including near 800 nm. In this embodiment, it is proposed to combine the advantages of a high gain diode-pumped gas laser and ICSHG, of a source such as but not limited to Rb gas emitting just near 800 nm. It should be understood that a line narrowing device 32 (shown in phantom) may be included to produce a narrower linewidth UV output. By way of example and not limitation, the line narrowing device 32 may be an intra-cavity etalon. In some embodiment, the line narrowing device 32 may also be an injection locking device to narrow the linewidth.

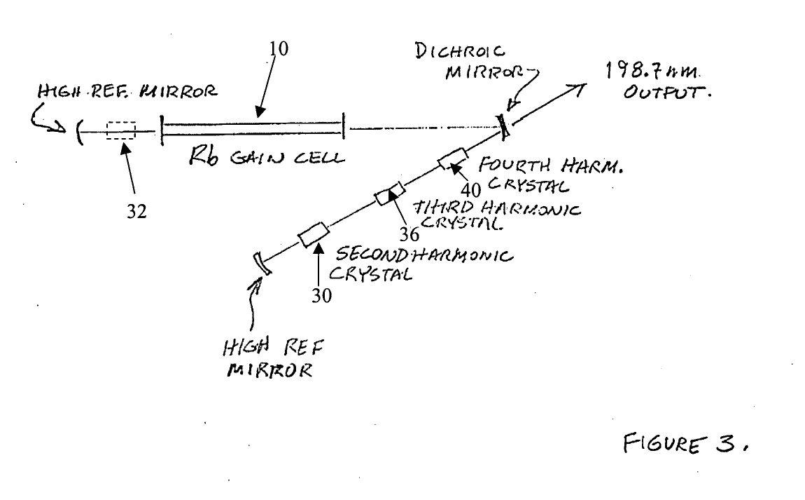

The concept of ICSHG of radiation from a Rb gas laser shown in FIG. 2 can be extended to generate third and fourth harmonics of 795 nm. For example, by incorporating additional nonlinear elements 36 into the optical cavity, the second harmonic radiation can be mixed with the circulating fundamental at 795 nm, generating 265 nm and further mixed with the fundamental to give 198.7 nm. This concept is illustrated in FIG. 3. Ekamples of crystals suitable for the third harmonic nonlinear conversion stage are LBO, BBO and CLBO. The fourth harmonic stage could employ nonlinear elements 40 such as but not limited to BBO or KBBF. In this embodiment, each crystal represents a stage of nonlinear conversion. It should be understood that other embodiments may use other methods or configurations of nonlinear conversion and may include other components besides just crystals. To minimize the complexity of the optical resonator, sequential intra-cavity nonlinear conversion such as this can be accomplished using type I, type II, and type I phase matching in the second, third and fourth harmonic steps, respectively. In this configuration, no additional polarization rotators are required. The multiple passes afforded by the intra-cavity configuration are especially useful in enhancing the conversion efficiency from crystals that are limited in size such as KBBF.

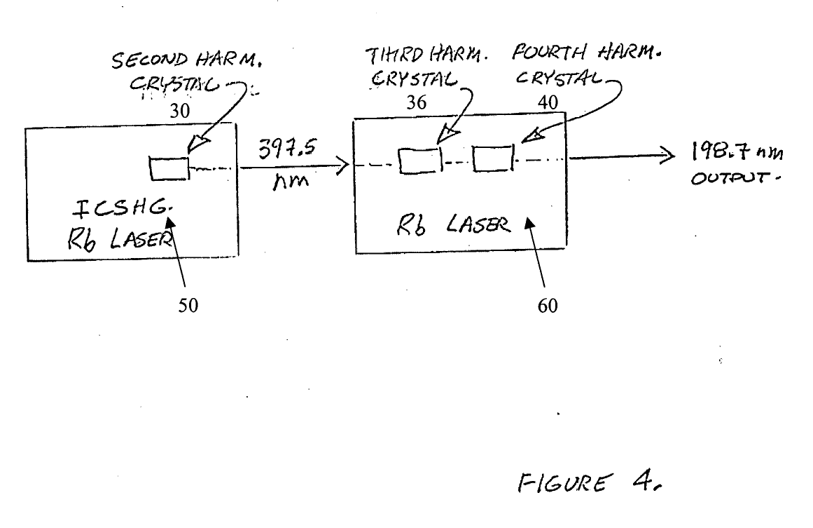

A further embodiment is shown in FIG. 4. Here the 397.5 nm output from a Rb ICSHG laser 50 is shown making a single pass through the resonant cavity of a second, free-running Rb 795 nm laser 60. The second laser may also be end-pumped in a configuration such as that shown in FIG. 2. The 397.5 nm beam is mixed with the second 795 nm resonant fundamental, producing the third harmonic in suitably phase matched crystals 36 such as those listed above. The third harmonic is further mixed with the fundamental to produce fourth harmonic output at 198.7 nm, again in the appropriate crystals 40, such as BBO and KBBF.

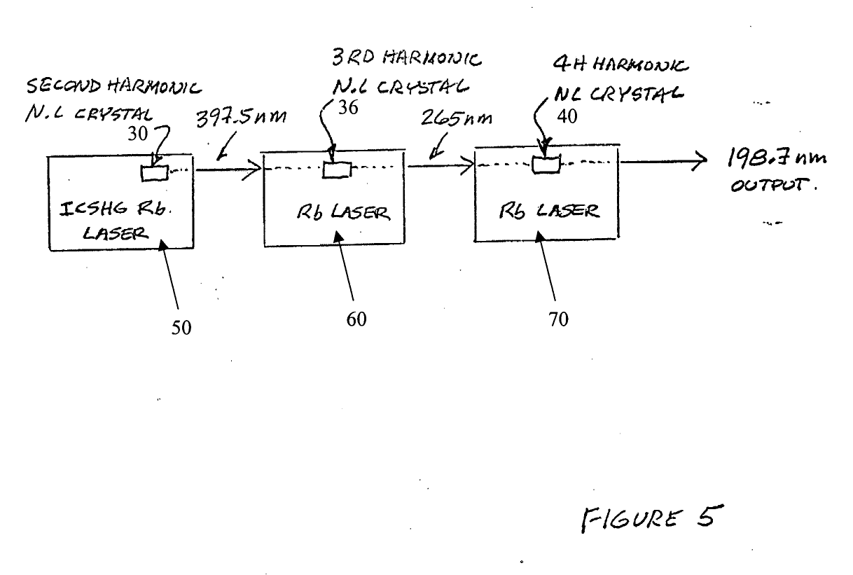

This concept is further extended in the embodiment shown in FIG. 5. Here the ICSHG Rb laser 50 radiation passes through a separate fundamental Rb laser 60, as above, to generate the third harmonic. This harmonic then passes through a third, free-running fundamental Rb laser 70 to generate the fourth harmonic.

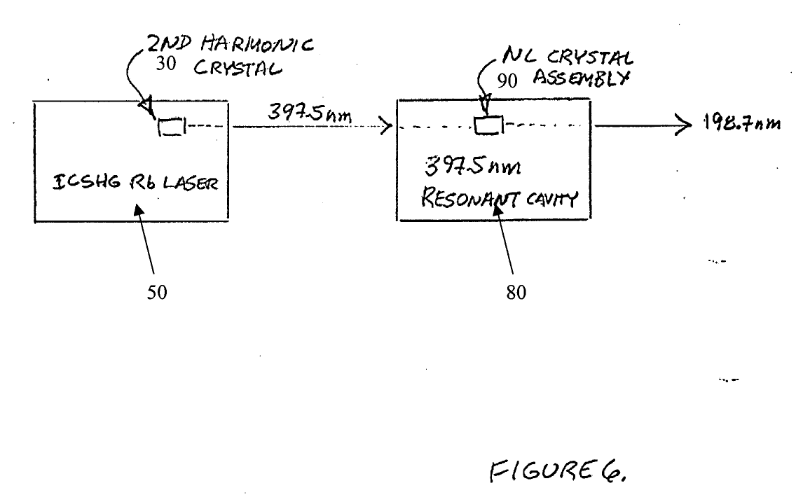

Yet another embodiment of a fourth harmonic system is shown in FIG. 6. The output from a Rb ICSHG 50 is directed into an external resonant cavity 80 which does not contain a Rb gain cell. This cavity can be tuned to have its resonances locked to the second harmonic of the Rb laser line at 397.5 nm. When the resonance is locked, the intra-cavity circulating optical intensity is enhanced by as much as a factor of 400. The external cavity contains a nonlinear element such as KBBF, which is phase-matched for second harmonic generation, of 198.7 nm.

The harmonic generation method of FIG. 6 is simple in principle and utilization of resonant frequency conversion of CW radiation into the deep UV has been already employed in commercial products producing CW fourth harmonic of Nd:YVO4 at 266 nm, and the second harmonic of Ar+ lasers at 244 nm. Generation of sub-200 nm light is, however, more challenging, as damage-resistant crystals with the appropriate phase matching properties become increasingly scarce as conversion proceeds deep into the UV. At present, the only known nonlinear crystal capable of being phase-matched for direct second harmonic generation at or below 200 nm, which is KBBF. In practice, the method of FIG. 6 might therefore require more elaborate types of harmonic elements and/or conversion schemes. In one example, a second harmonic element might comprise of a stack of a number of thin plates of KBBF. Alternatively, the frequency conversion scheme may employ multiple passes through a single thin piece, with control of the harmonic phase relationships by means of thin film dielectrics, angle, temperature, dispersive gas fill pressure, externally applied field, etc. As still another alternative, nonlinear materials such as CLBO, LBO, BBO, BaMgF₄, BaZnF₄ and potassium pentaborate, which are transparent deep into the UV but cannot ordinarily phase match for SHG of 200 nm, might be constructed via some form of quasi phase matching. Periodic electrical poling of a crystal provides one example of practical implementation of this technique.

Some embodiments of the present invention may be designed to provide laser output at sub-200 nm frequency with certain attributes. Specifically, some may have a center wavelength <200 nm, a linewidth of approximately 3 pm, and an average power >200 mW. Some embodiments may desire to have minimum power output of at least 200 mW, at least 500 mW, or at least 1 watt. Some embodiments prefer to have laser output of at least 4 watts. Embodiments of the present invention may be designed to meet such power requirements. The present invention also provides embodiments of lasers that are solid-state diode-pumped lasers, continuous wave devices. They are efficient (30-40% efficient), compact, and can run for thousands of hours.

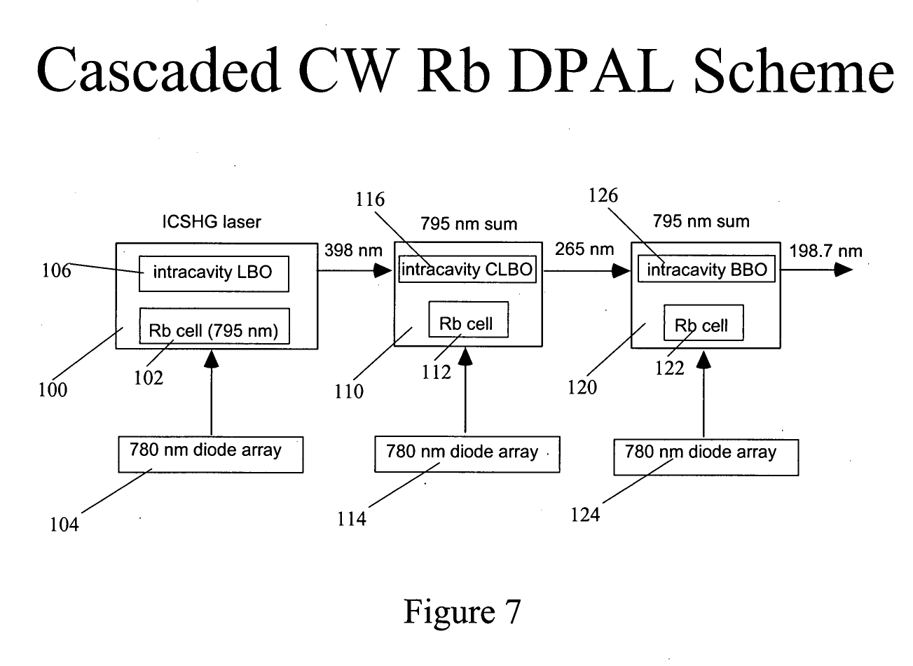

Referring now to FIG. 7, a schematic showing one embodiment of the present invention will now be described. FIG. 7 shows a laser employing a cascaded CW Rb DPAL scheme. FIG. 7 shows a first module 100 with a first alkali gain cell 102 that is pumped by a first laser diode 104. Using a module with a configuration similar to that shown in FIG. 2, the output from the alkali gain cell 102 is directed to a first nonlinear element 106 that may be phased-matched for second harmonic generation. The first module 100 may use a resonator as shown in FIG. 2 (but not shown in FIG. 7 for ease of illustration). The output from the first resonator in the first module 100 will then be directed to the second module 110. The second module 110 includes a second alkali gain cell 112 that is pumped by a second laser diode 114. Using a module with a configuration similar to that shown in FIG. 2, the output from the alkali gain cell 112 is directed to a second nonlinear element 116 that may be phased-matched for third harmonic generation. Again, the second module 110 may also include a resonator as shown in FIG. 2 (but not shown in FIG. 10 for ease of illustration). The output from the second resonator in the second module 110 may be directed to a third module 120. The third module may have a third alkali gain cell 122 that is pumped by a third laser diode 124. Using a module with a configuration similar to that shown in FIG. 2, the output from the alkali gain cell 122 is directed to a third nonlinear element 126. Optionally, some embodiments of the present invention which desire to have a laser output of 265 nm may be designed without a third module 120.

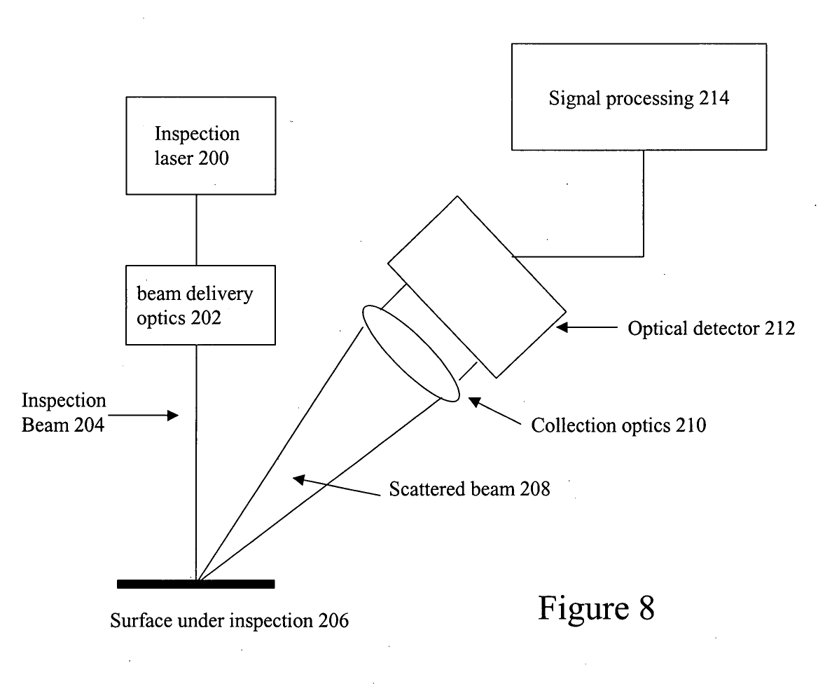

Referring now to FIG. 8, a device for use in inspection, and particularly semiconductor sample inspection, will now be described. By way of example and not limitation, FIG. 8 shows an embodiment having an inspection laser 200. It should be understood that the inspection laser 200 may be any of the laser systems described in this application. Some embodiments of the laser 200 may have an ultraviolet output at a wavelength in the range of about 265-270 nm. Other embodiments may generate an ultraviolet output at sub-200 nm wavelengths. The laser 200 generates output into beam delivery optics 202 which directs an inspection beam 204 to a sample with a surface under inspection 206. The surface 206 under inspection may be a sample such as but not limited to a patterned semiconductor wafer, a bare semiconductor wafer, a reticle, a mask, or the like. FIG. 8 shows that scattered beam 208 from sample 206 is received by collection optics 210 which is coupled to optical detector 212 and signal processing 214.

It is finally noted that the Rb gain cell used in most of the foregoing discussion and the accompanying drawings as the primary source of fundamental radiation near or just below 800 nm, was provided as an illustrative example and not by way of limitation. For example, gases other than Rb that emit radiation at alternative wavelengths may also still fall within the scope of the invention when employed in conjunction with one or more of the harmonic techniques described herein to provide wavelengths in the deep UV portion of the spectrum.

Alternative power-scalable sources are known that may benefit from the frequency conversion techniques described in FIGS. 2 through 7, as long as the gain is high enough and thermal lensing issues can be overcome. Examples include one of several existing solid-state laser based systems including Cr-doped materials such as Cr:LiSAF, Ti:sapphire and optically pumped semiconductor-based gain media. Semiconductor based lasers have demonstrated extremely high gains, and systems based on this technology operating near 980 nm have demonstrated excellent power scaling potential—well into the multiple watt regime. As for Cr:LiSAF and other similar Cr-doped colquiriites, these may be pumped directly by diodes but desire them to be of sufficiently short wavelengths—typically near or below 670 nm. The development of such diodes lags behind the more standard 800 nm diodes and this is the primary impediment to power scaling diode-pumped Cr-doped laser to the 10 W or above. Sufficiently powerful red diodes with outputs in the 600-750 nm may be used to allow scaling of Cr-based and/or semiconductor gain media to the power levels that are compatible with the frequency conversion techniques of the present invention. It is also important to note that an important distinction here between these two classes of materials is that Cr-doped media are generally of much lower gain than optically pumped semiconductors and may therefore desire operation at higher powers to overcome losses introduced by additional line narrowing elements in the cavity.

The third type of solid-state medium compatible with CW and/or quasi-CW operation is Ti-sapphire. This laser has the necessary gain for line narrowing to obtain the requisite narrow bands for the frequency conversion techniques discussed above to be efficaciously implemented, but—because of its short stimulated emission lifetime and absorption in the green region, Ti:sapphire is typically pumped by another laser, such as a green Nd-doped laser. To achieve operation at or above 10 W a green laser pumping source with output power approaching 100 W is desired. Such sources may be used thereby to make Ti:sapphire a source of fundamental near-IR radiation that would be compatible with the frequency conversion methods described herein.

As for operational modes, quasi-CW lasers operate at a sufficiently high repetition rate that they appear to be CW for some particular applications. For example and not limitation, a repetition rate of 200 MHz is considered quasi-CW for inspection applications while a repetition rate of only 100 kHz is considered quasi-CW for stereolithography. A CW laser can be operated quasi-CW by pulsing the pump diodes, mode-locking the laser or the like. Operating the laser in a quasi-CW mode can be advantageous since, for a fixed average power the peak power is increased. This leads to higher conversion efficiency for the nonlinear frequency conversion process.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, the sub-200 nm laser output may be adapted for use in a semiconductor inspection device. Any of the above embodiments may be used with creating a sub-270 nm laser output for use in a semiconductor inspection device. For any of the above embodiment, the alkali vapor in the gain cell may be selected from the group consisting of cesium (Cs), rubidium (Rb), potassium (K), sodium (Na), and lithium (Li). Any of the above embodiments may find application in the inspection process for semiconductor photolithography. Although the figures show the use of an Rb gain cell for ease of illustration, it should be understood that some other embodiments of the invention may use gain cells containing other materials as set forth herein.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All patents and publications mentioned herein are incorporated herein by reference to disclose and describe the structures and/or methods in connection with which the publications are cited.

Expected variations or differences in the results are contemplated in accordance with the objects and practices of the present invention. It is intended, therefore, that the invention be defined by the scope of the claims, which follow, and that such claims be interpreted as broadly as is reasonable.

1. A laser system comprising:
a gas laser for producing near infrared output;
a diode pump source for pumping the gas laser, and
at least two nonlinear conversion stages;
wherein the laser system produces a narrow linewidth ultraviolet output.

2. The system of claim 1 wherein the ultraviolet output has a wavelength less than 300 nm.

3. The system of claim 1 wherein the ultraviolet output has a wavelength between 260 and 270 nm.

4. The system of claim 1 wherein the ultraviolet output has a wavelength between 190 and 200 nm.

5. The system of claim 1 wherein the diode pump source is selected from one of the following: a laser diode bar, a laser diode stack, or a laser diode array.

6. The system of claim 1 wherein the diode pump source is selected from one of the following: an optically concentrated laser diode bar, an optically concentrated laser diode stack, or an optically concentrated laser diode array.

7. The system of claim 1 wherein the diode pump source is line-narrowed.

8. The system of claim 1 wherein the ultraviolet output is CW.

9. The system of claim 1 the ultraviolet output is quasi-CW.

10. The system of claim 1 further comprising a line narrowing device to produce a narrower linewidth UV output.

11. The system of claim 10 wherein the line narrowing device comprises an intra-cavity etalon.

12. The system of claim 1 including more than one diode-pumped gas laser.

13. The system of claim 1 wherein at least one of the nonlinear conversion stages uses a nonlinear crystal.

14. The system of claim 13 wherein the nonlinear crystal is made of at least one of the following: LBO, BBO, CLBO, KNbO₃, KBBF, PPLN, PPLT, BIBO, KABO, BABF, BABO, LB4 and GdYCOB.

15. The system of claim 1 wherein at least one of the nonlinear conversion stages is positioned so that nonlinear conversion takes place within an optical cavity of the gas laser.

16. The system of claim 1 wherein at least one of the nonlinear conversion stages is positioned so that the nonlinear conversion takes place within an external resonant cavity.

17. The system of claim 1 wherein the gas laser is an alkali metal vapor laser.

18. The system of claim 17 wherein the alkali metal vapor is made of at least one of rubidium, cesium, potassium, sodium or lithium.

19. The system of claim 1 wherein linewidth of the ultraviolet output is less than 10 GHz.

20. The system of claim 1 wherein power of the ultraviolet output is more than 200 mW.

21. The system of claim 1 wherein power of the ultraviolet output is more than 500 mW.

22. The system of claim 1 wherein power of the ultraviolet output is more than 1 W.

23. The system of claim 1 wherein the output is used for inspection.

24. The system of claim 1 wherein the output is used for semiconductor inspection.

25. The system of claim 1 wherein the output optically directed towards a semiconductor wafer.

26. The system of claim 1 wherein the diode pump source pumps the gas laser to produce near infrared output, wherein the near infrared output is converted by the at least two nonlinear conversion stages to produce a narrow linewidth ultraviolet output.

27. The system of claim 1 wherein the diode pump source pumps the gas laser to produce near infrared output, wherein the near infrared output is a beam passing through at least two nonlinear conversion stages to produce a narrow linewidth ultraviolet output.

28. The system of claim 1 wherein output of the gas laser is between 750 and 810 nm.

29. A method of producing narrow linewidth ultraviolet light, the method comprising:
providing a gas laser for producing near infrared output, a diode pump source for pumping the gas laser, and at least one nonlinear conversion stage; and
producing an ultraviolet output that is a harmonic of the infrared output.

30. The method of claim 29 wherein the ultraviolet output has a wavelength below 300 nm.

31. The method of claim 29 wherein the harmonic is the third harmonic.

32. The method of claim 29 wherein the ultraviolet output has a wavelength between 260 and 270 nm.

33. The method of claim 29 wherein the harmonic is the fourth harmonic.

34. The method of claim 29 wherein the ultraviolet output has a wavelength between 190 and 200 nm.

35. The method of claim 29 wherein the diode pump source is a laser diode bar, stack or array.

36. The method of claim 29 wherein the diode pump source is an optically concentrated laser diode bar, stack or array.

37. The method of claim 29 wherein the ultraviolet output is CW.

38. The method of claim 29 wherein the ultraviolet output is quasi-CW.

39. The method of claim 29 further comprising using a line narrowing technique to produce a narrower bandwidth.

40. The method of claim 39 wherein the line narrowing technique includes an intra-cavity etalon.

41. The method of claim 29 including more than one diode-pumped gas laser.

42. The method of claim 29 wherein at least one of the nonlinear conversion stages uses a nonlinear crystal.

43. The method of claim 42 wherein the nonlinear crystal is made of at least one of LBO, BBO, CLBO, KNbO3, KBBF, PPLN, PPLT, BIBO, KABO, BABF, BABO, LB4 and GdYCOB.

44. The method of claim 29 wherein nonlinear conversion takes place within an optical cavity of the gas laser.

45. The method of claim 29 wherein nonlinear conversion takes place within an external resonant cavity optically coupled to the gas laser.

46. The method of claim 29 wherein the gas laser is an alkali metal vapor.

47. The method of claim 46 wherein the alkali metal vapor is made of at least one of rubidium, cesium, potassium, sodium or lithium.

48. The method of claim 29 wherein linewidth of the ultraviolet output is less than 10 GHz.

49. The method of claim 29 wherein power of the ultraviolet output is more than 200 mW.

50. The method of claim 29 wherein power of the ultraviolet output is more than 500 mW.

51. The method of claim 29 wherein power of the ultraviolet output is more than 1 W.

52. The method of claim 29 wherein the output is used for inspection.

53. The method of claim 29 wherein the output is used for semiconductor inspection.

54. The method of claim 29 wherein the output optically directed towards a semiconductor wafer.

55. The method of claim 29 wherein the output of the gas laser has a wavelength between 750 and 810 nm.

56. The method of claim 29 wherein the gas laser is pumped by the diode pump source to produce the near infrared output which is received by the at least one nonlinear conversion stage, producing an ultraviolet output that is a harmonic of the infrared output.

57. A laser system comprising:
a high gain laser for producing output between 750 and 800 nm;
a diode pump source for pumping the laser, and
at least two nonlinear conversion stages;
wherein the laser system produces a narrow linewidth ultraviolet output at a wavelength shorter than 300 nm.
